(19) United States
(12) Patent Application Publication
(10) Pub. No.: US 2010/0293203 A1
(43) Pub. Date: Nov. 18, 2010

(54) USER INTERFACE FOR GRAPH DATABASE DATA

(76) Inventor: Henry Roberts Williams, New York, NY (US)

Correspondence Address: MERCHANT & GOULD PC, P.O. BOX 2903, MINNEAPOLIS, MN, 55402-0903, US

(21) Appl. No.: 12/782,496

(22) Filed: May 18, 2010

Related U.S. Application Data
(60) Provisional application No. 61/216,507, filed on May 18, 2009.

(51) Int. Cl. G06F 17/30; G06F 3/048

(52) U.S. Cl. 707/805; 715/769; 707/E17.005

(57) ABSTRACT

A user interface displays data from a graph database, including the records from the database and the relationships between the records. The user interface includes a graphical element that displays whether a given record is connected to other records, and if so, the graphical element is selectable to display the other connected records. Drag and drop connection of records in the graph database using a graphical user interface is also disclosed.

### CROSS REFERENCE TO RELATED APPLICATIONS

This application claims priority to U.S. Provisional Application No. 61/216,507 filed on May 18, 2009, entitled MULTI-DIMENSIONAL DATA GRID FOR VIEWING RECORDS IN A DATABASE, the disclosure of which is incorporated by reference herein in its entirety.

### BACKGROUND

There are various different types of databases for storing data. Two common types of databases include relational databases and graph databases. A relational database includes data sets (such as tables), which group data elements together that share a common characteristic. For example, a data set might include all data that was generated in a given year, while another data set might include all data including a given keyword.

A graph database, on the other hand, stores data using nodes and edges. Record data is stored as a node, while the relationships between the data are stored as edges. This type of database allows software applications to easily identify and manage relationships between the data.

Computers can be used to display data from a database in a user interface, such as through a display device, to permit users to view the data contained therein.

### SUMMARY

In general terms, this disclosure is directed to the display of data from a graph database using a graphical user interface. In one possible configuration and by non-limiting example, the graphical user interface generates and displays a multi-dimensional data grid.

One aspect is a method of displaying data from a graph database, the method comprising: generating a user interface including a representation of a record from the graph database; determining that the record is connected to at least one other record in the graph database; and generating a selectable graphical element in the representation of the record in the user interface, the selectable graphical element graphically illustrating that the record is connected to at least one other record in the graph database.

Another aspect is a method of creating connections between a first record and a second record in a graph database, the method comprising: receiving an input from a user into at least one user interface object of a graphical user interface, the input being a drag and drop input identifying first and second records in the at least one user interface object with an input device; and creating a connection in the graph database between the first record and the second record.

### BRIEF DESCRIPTION OF THE DRAWINGS

FIG. 1 is a schematic block diagram of an example computing environment.

FIG. 2 is a schematic block diagram illustrating an example computing device.

FIG. 3 is a schematic block diagram illustrating exemplary data stored in a graph database, the data including records and edges.

FIG. 4 is a schematic block diagram graphically depicting the data stored in the graph database shown in FIG. 3.

FIG. 5 is a screen shot of an example graphical user interface displaying data from the graph database data shown in FIGS. 3 and 4.

FIG. 6 is another screen shot of the example graphical user interface shown in FIG. 5.

FIG. 7 is another screen shot of the example graphical user interface shown in FIG. 6.

FIG. 8 is a screen shot of another example graphical user interface.

FIG. 9 is a screen shot of another example graphical user interface.

FIG. 10 is another screen shot of the example graphical user interface shown in FIG. 9.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

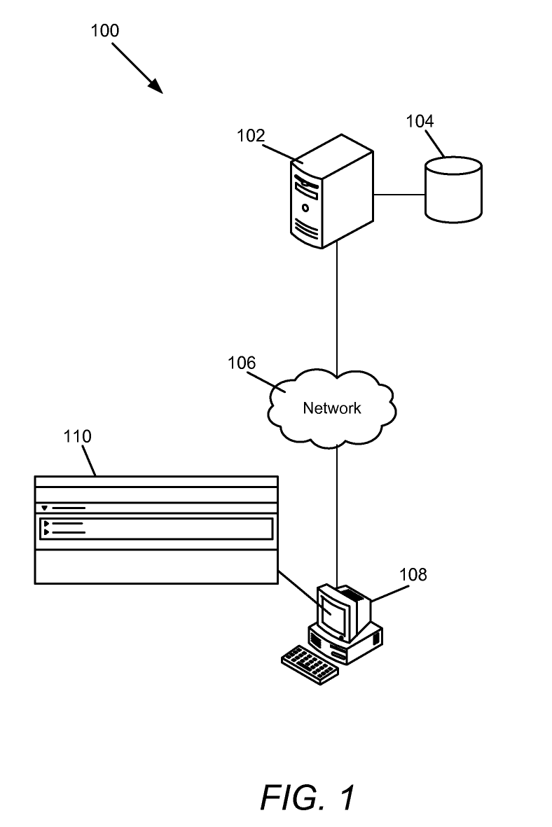

FIG. 1 is a schematic block diagram of an example computing environment 100. The example computing environment includes server 102, database 104, network 106, and computer 108. In some embodiments, computer 108 generates a user interface display including user interface object 110.

Server 102 is, for example, a computer that provides access to web applications. In some embodiments, the server communicates data with network 106 according to a standard network communication protocol. The web applications operating on the server typically generate data in a form that can be interpreted by a Web browser. An example of such a form is a markup language, such as HTML. The data is then communicated across network 106. Server also receives data from network 106, such as relating to inputs provided by the user into client computer 108, or data provided by client computer 108.

Database 104 is a memory device that contains an organized collection of data. Server 102 is configured to communicate with database 104 to store data in database 104 and to retrieve data from database 104. In some embodiments, database 104 is a graph database that stores data including records and edges. The records include data that can be arranged in fields. Edges define the relationships between records in the database 104.

Network 106 is a data communication network, such as the Internet. In this example, network 106 operates to communicate data between server 102 and computer 108.

Computer 108 is a client computing device capable of data communication with network 106. In some embodiments, computer 108 includes a web browser software application that runs on computer 108. Computer 108 receives data from server 102 through network 106. The data is interpreted by the web browser, which generates a user interface on the computer's display device. A user interface object 110, such as a multi-dimensional data grid can be displayed on the display device.

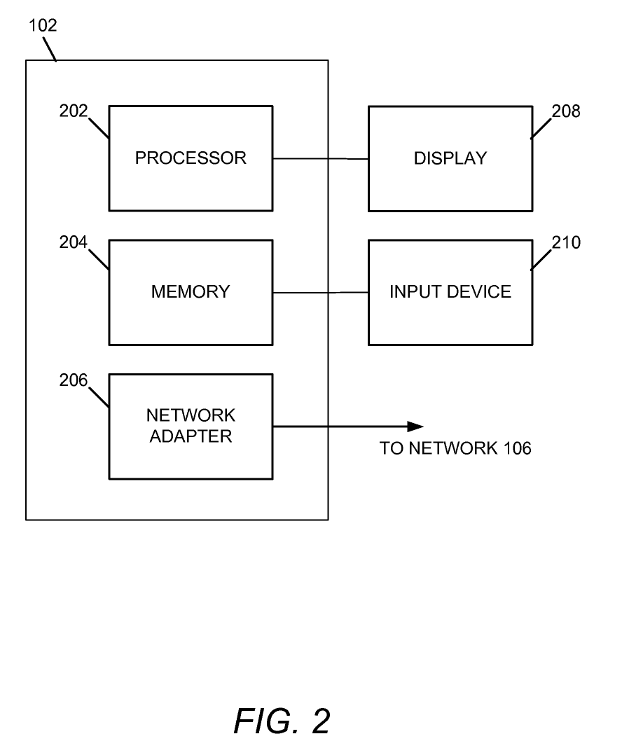

FIG. 2 is a schematic block diagram illustrating an architecture of an example computer 102 for implementing aspects of the present disclosure. The example architecture is also an example of computer 108, or other computers for implementing aspects of the present disclosure.

In some embodiments, computer 102 includes processor 202, memory 204, network adapter 206, display 208, and input device 210.

An example of processor 202 is a central processing unit.

Memory 204 stores computer-executable instructions, which when executed by the processor, perform one or more of the methods, operations, or functions disclosed herein. An example of computer-executable instructions is a software application. Another example of computer-executable instructions is a browser software application that generates a user interface from data received from network adapter 206.

Network adapter 206 sends and receives data across a communication network 106, such as the Internet.

Display 208 generates a user interface that can be viewed by the user. In some embodiments, the user interface displays a user interface object, as discussed herein.

Input device 210 receives input from a user. An example of an input device is a mouse.

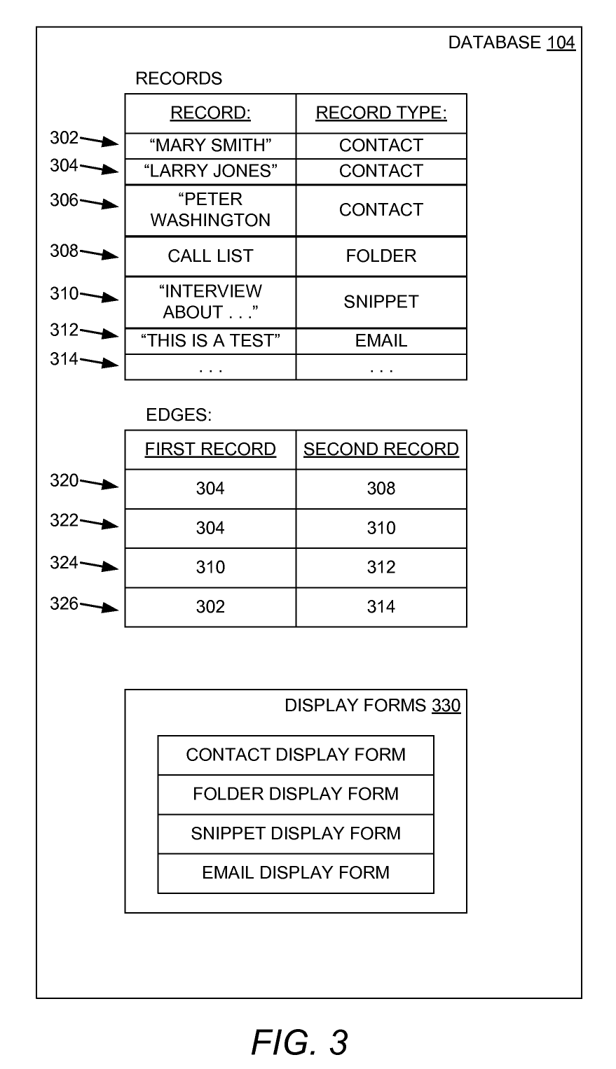

FIG. 3 is a schematic block diagram of database 104 illustrating data stored in database 104. In this example, database 104 is a graph database. The data within database 104 includes records and edges. The records include records 302, 304, 306, 308, 310, 312, and 314. The edges include edges 320, 322, 324, and 326. Display forms 330 are also included in some embodiments of database 104 as discussed in more detail herein.

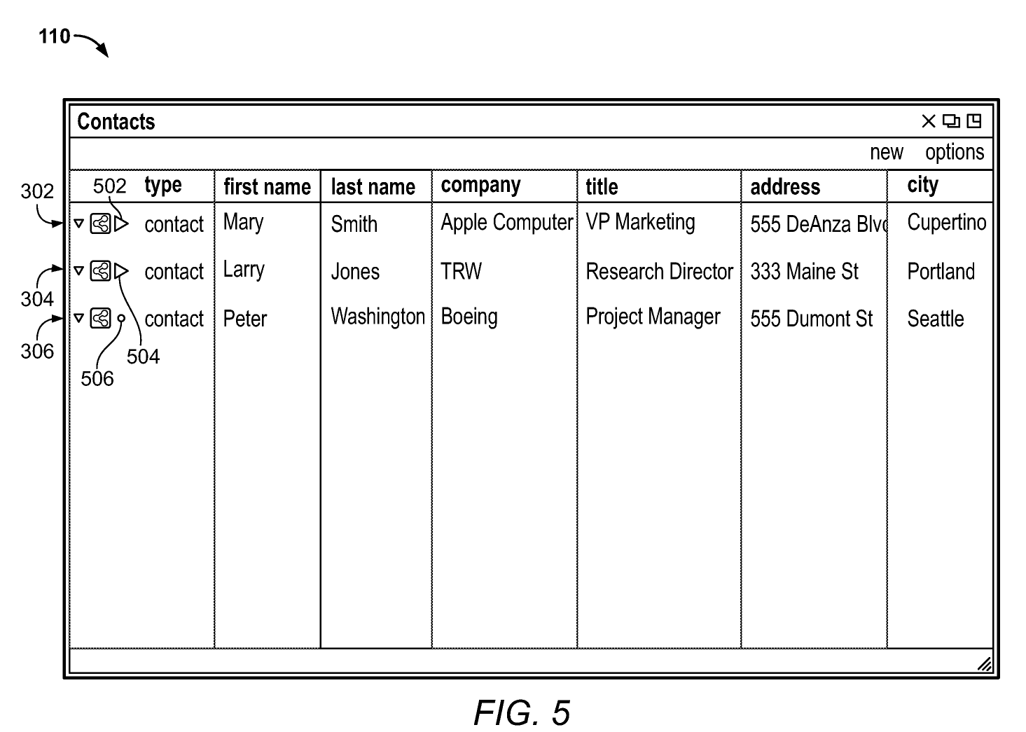

Each record can include various types of data. In some embodiments the record data is stored in fields. For example, record 302 includes a type of “contact.” The record can include additional data arranged in a plurality of fields. An example of field data (e.g., shown in FIG. 5) includes a first name (“Mary”), last name (“Smith”), company (“Apple Computer”), title (“VP Marketing”), address (“555 DeAnza Blvd.”), City (“Cuper”), etc. Other records can include other data, as desired. Additional examples of records 304, 306, 308, 310, 312, and 314 are also illustrated in FIG. 3.

Records are connected with other records via edges, which are stored in database 104. For example, edge 320 defines a connection between record 304 (“Larry Jones” contact) and record 308 (“Call List” folder). Edge 322 defines a connection between record 304 (“Larry Jones” contact) and record 310 (“Interview . . . ” snippet). Edge 324 defines a connection between record 322 (“Interview . . . ” snippet) and record 312 (“This is a test” e-mail).

Record 314 and edge 326 illustrate that additional data can be included in database 104 as well. In this example, no connections are included in database 104 for record 306 (“Peter Washington” contact).

Display forms 330 are described in more detail below.

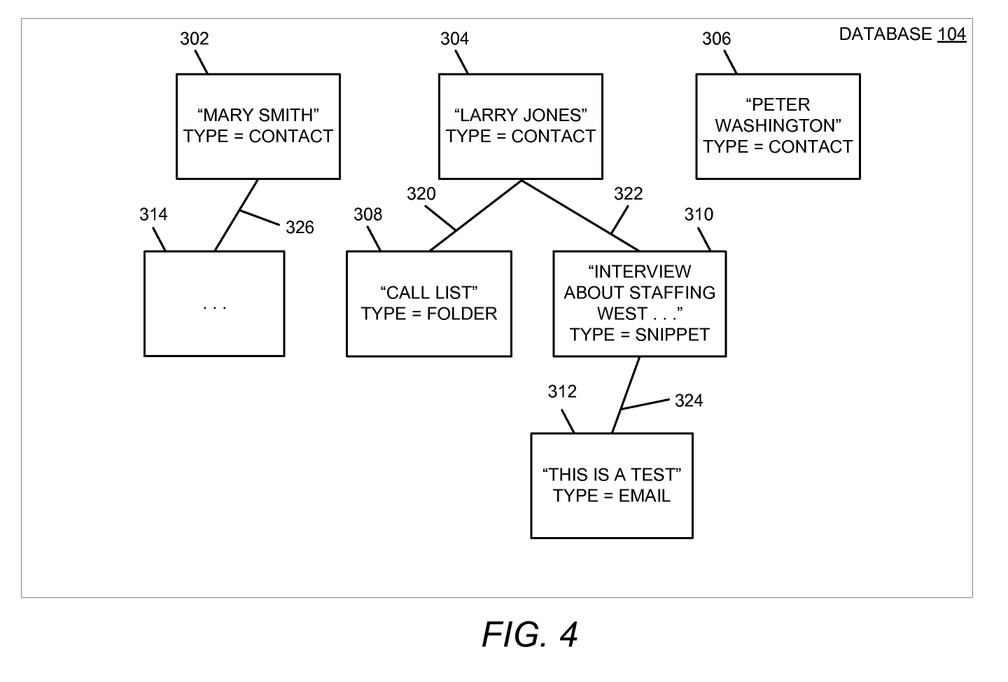

FIG. 4 graphically illustrates the data and relationships defined in the example data stored in the example database 104 shown in FIG. 3.

Record 304 (“Larry Jones” contact) is connected with record 308 (“call list” folder) by edge 320, and with record 310 (“Interview About Staffing West Coast Office” snippet) by edge 322. Record 310 (“Interview . . . ” email) is itself connected to record 312 (“This is a Test” email) by edge 324.

Record 302 (“Mary Smith” contact) is connected with one or more other records, as illustrated by record 314, which is connected by edge 326.

As noted above, contact record (“Peter Washington”) is not connected to any other record in database 104.

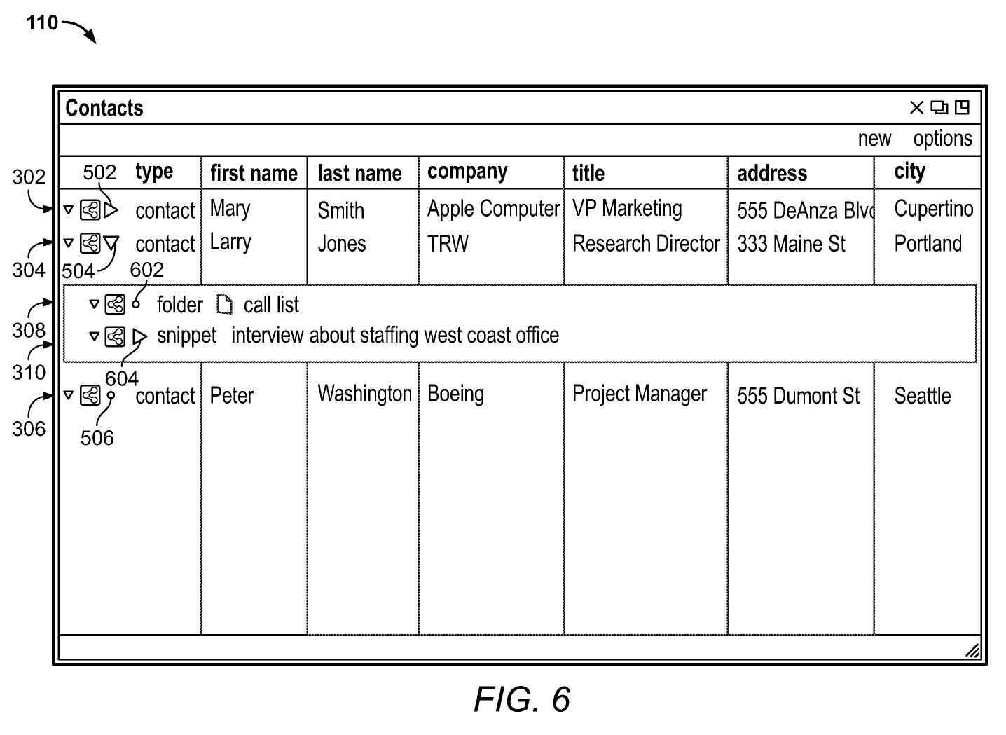

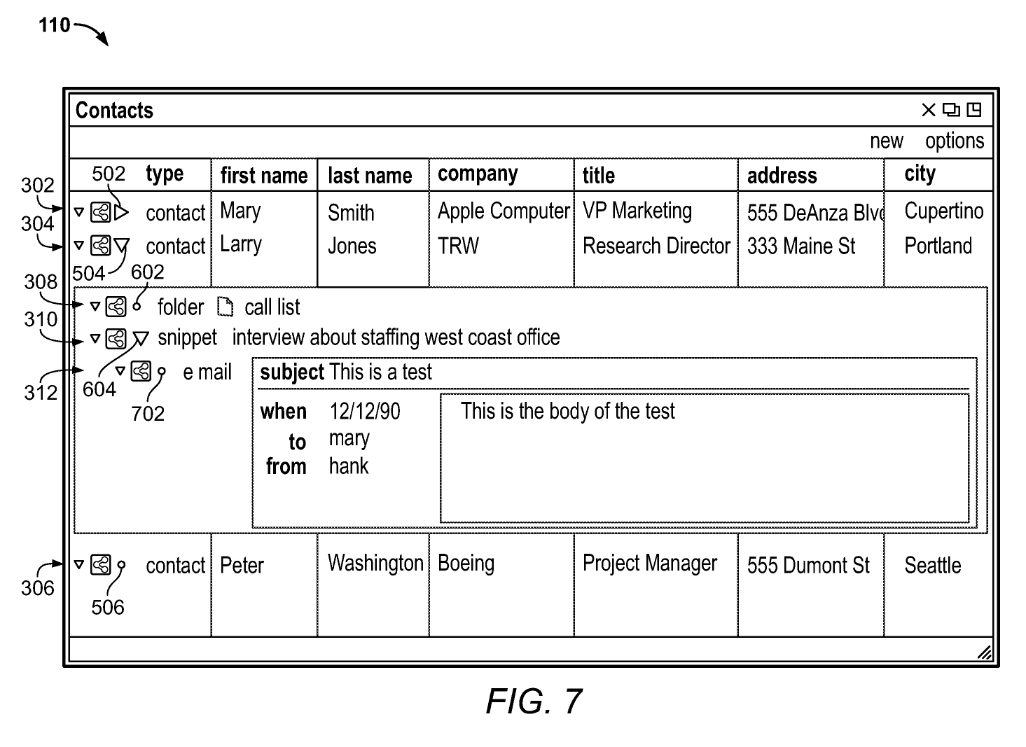

FIGS. 5-7 illustrate various aspects with reference to a graphical user interface. In these examples, the graphical user interface includes graphical user interface object 110, such as a multidimensional data grid. FIG. 5 is a screen shot of the graphical user interface object 110. FIG. 6 is another screen shot of the graphical user interface object 110 after opening a handle of one of the records. FIG. 7 is another screen shot of the graphical user interface object 110 after opening a handle of another of the records. FIGS. 5-7 illustrate an example in which a collection of contact records from database 104 are displayed.

In some embodiments, the graphical user interface is part of a graphical user interface builder for creating database applications. A data grid is part of the graphical user interface builder, in some embodiments. The data grid is a user interface object that can be arranged on an interface screen by a developer, such as for use in the database application. This object can be configured to display, for example, a collection of rows and columns that are pulled from database 104 based on a query. For example, each row of the data grid represents one record in the database, and each column represents one field of that record.

Some embodiments include a multidimensional data grid. In some embodiments the multidimensional data grid looks and behaves in a similar manner to the standard data grid which queries a database to get data which populates the grid with scrolling rows that represent data in a database. However, the multidimensional data grid operates in conjunction with a graph database, in some embodiments, which allows any record in the database to be connected, via an edge, to any other record.

In this context, any record in the database can be connected to any other record and these connections are displayed in the multidimensional data grid. For example, the multidimensional data grid implements a tree metaphor. Each row in the multidimensional data grid, such as shown in FIG. 5, has a handle 502, 504, and 506 on the left side of it. The handle 502, 504, and 506 is a graphical element displayed in the respective row of the multidimensional data grid. The handle is graphically represented in the user interface with a graphical element in the shape of a triangle (e.g., handles 502 and 504), for example, if the respective record has other records in the database that are connected to it. The triangular handles (502 and 504) graphically illustrate that the records have connected records that can be displayed in the multidimensional data grid 110. In addition, in some embodiments the handle (502 and 504) operates as a selectable control to alternate the control between open and closed positions, as discussed below. Otherwise, the handle (e.g., 506) includes a graphical element in the shape of a circle (e.g., handle 508), indicating that there are no records connected to the record (e.g., 506).

If the handle in a given record is displayed as a triangle (e.g., handles 502 and 504), then the record has other records that are connected to it. When the triangle, such as handle 504 for contact record 304 (“Larry Jones”), is clicked, the multidimensional data grid is updated as shown in FIG. 6 to show all (or a subset) of the items that are connected to it in the database 104, including folder record 308 (“call list”) and snippet record 310 (“interview . . . ”). In some embodiments, the connected database records (e.g., 308 and 310) are displayed as being indented and below the given row, as shown in FIG. 6. This is the open position for the handle 504. When open, handle 504 points down. When the open handle (e.g., handle 504) is clicked again, the related records 308 and 310 are hidden and the handle reverts to the closed position.

In addition, each of the records shown under the given record also has a handle next to it, such as handle 602 for record 308 and handle 604 for record 310. Again, if any of those handles is in the form of a triangle, such as handle 604, then that triangle handle may also be clicked on to reveal all or a subset of the other items in database 104 that are connected to it, as shown in FIG. 7. In this example, record 310 is itself connected to email record 312 (“This is a test”), which includes handle 702.

Note that, in some embodiments, each record in database 104 has one or more layout types. So the items that are shown as being related to a given item that appear indented and under that item will have an appearance that can be designed to look whatever way the developer wants that item to look, as defined by the respective display form 330 (shown in FIG. 3). These layout display forms 330 are created using a form layout editor. For example, the email record 312, shown in FIG. 7, is displayed in the multidimensional data grid 110 to have a given appearance for records having the email type as defined by the respective email display form.

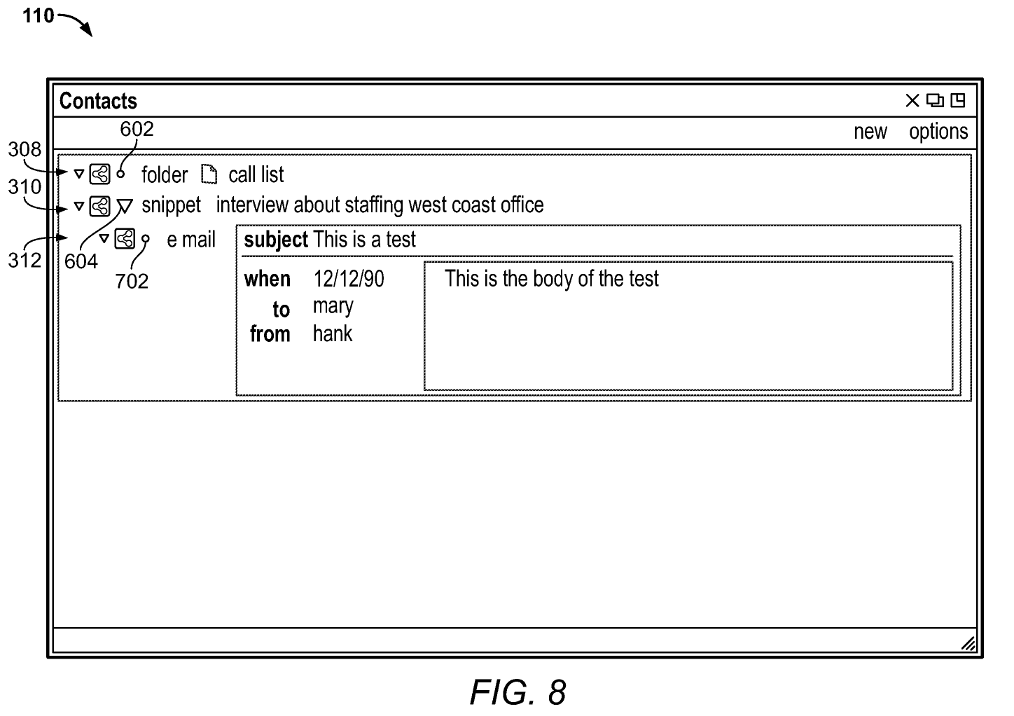

Although the multidimensional data grid can be similar in some embodiments to a standard data grid in terms of being formatted with rows and columns, this is but a specific embodiment of the multidimensional data grid. In other embodiments, the top level items (e.g., records 302, 304, and 306) are not represented as rows and columns but as a list of formatted records with custom layouts. An example user interface object 110 that includes a list of formatted records rather than a row and column format is shown in the example user interface of FIG. 8. In yet another possible embodiment, a list of contacts may be represented as a series of rows and columns where each column represents a name, address, city state and zip code. Or, that same collection of contacts could be represented as a collection of vertically listed forms that use a business card format/layout in yet another embodiment.

A multidimensional data grid may, for each row, show the record type for each record that is being displayed. This is significant because the connections between records will often not be of the same type. So, for example, a contact record might be connected to an email record or an event record. It is often valuable when displaying heterogeneous data types to show the record type in the user interface. In one embodiment, when the multidimensional data grid is configured to show this information, it is displayed at the left side of the given record (as shown in FIGS. 5-7).

A multidimensional data grid may also show the type of the connection between records. When a given record has related records, and those records are being shown indented and below that given record, each of these related “children” may show a label reflecting the type of the connection.

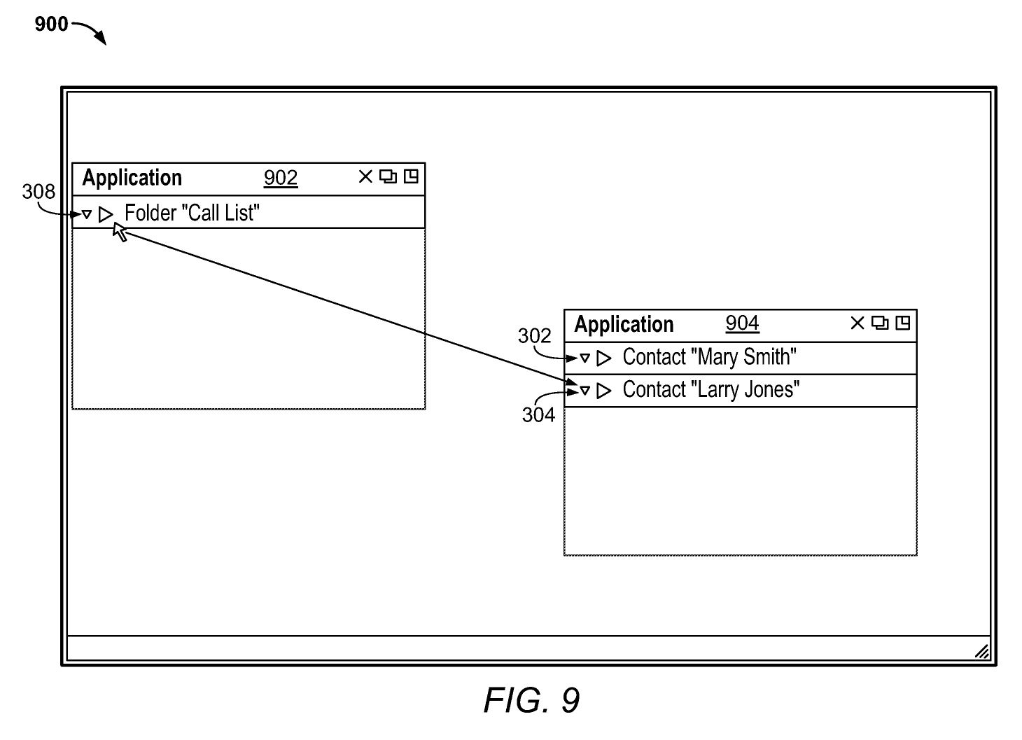

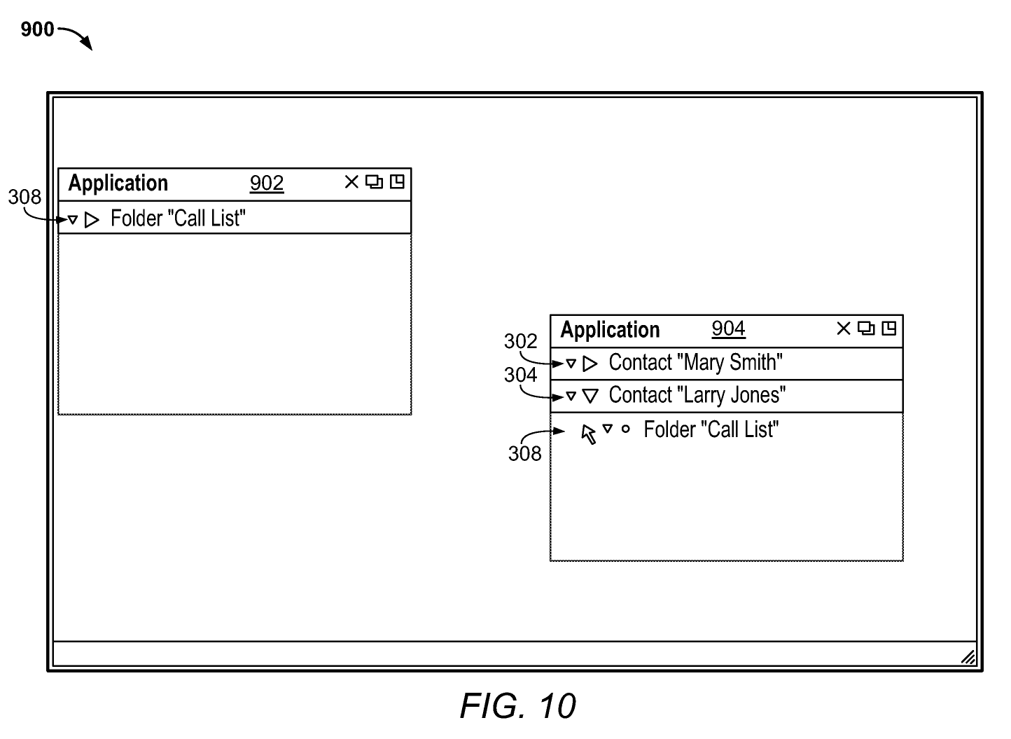

Beyond being able to display the graph structure of information using the tree metaphor, the multidimensional data grid 110 can also allow the user to create connections in the graph database between records, by allowing the user to drag and drop items either within one multidimensional data grid or between different multidimensional data grids. An example method of connecting records is illustrated in FIGS. 9-10, which illustrate an example user interface 900 including a first application 902 and a second application 904. Another example embodiment utilizes a single application 902.

This concept is important because, in one embodiment, applications (e.g., 902 and 904) using multidimensional data grids will be run on an internet browser based desktop that hosts applications from different developers or vendors, but where the database 104 is common between them. In this case, using the drag and drop model, a record being displayed in one multidimensional data grid in an application 902 written by developer A could be connected to a record being displayed in a multidimensional data grid in an application 904 written by developer B.

In the case where the database 104 is common between different applications 902 and 904 written potentially by different vendors and accessible by many different users, each record will have a set of permissions associated that is similar to the kinds of permissions that are accessible in an operating system such as Unix. Such permissions include read, read/write, and administer. In this case a multidimensional data grid would only be able to show a given user data that s/he had permission to see. Multidimensional data grids may be configured to specify, within the scope of what a given user has the right to see, additional limiting filters. For example though the user might have permission to see all of the items owned by a specific user, the application developer or the given user could configure the multidimensional data grid to not see those records so as to avoid the clutter that such broad visibility might create.

The way drag and drop works in this context is that the given record 308 is “grabbed” using the standard GUI model for dragging an item using a mouse, such as shown in FIG. 9. The cursor is then moved (as illustrated by the arrow in FIG. 9) over the target item (e.g., record 304) until it is highlighted. The item is then released on top of the target item. The multidimensional data grid will then ask the database what types of connections are valid and ask the user to select the appropriate connection type from a list. Under certain circumstances the system may not bring up a list of choices if there is only one valid choice or if there is one appropriate default choice. This is done to simplify use under certain circumstances.

Once the record is dropped on top of its target, and the message is sent to the database to connect the records, the dropped record 308 will typically appear indented and below the target item, as shown in FIG. 10. The multidimensional data grid may be configured to not show this particular type of item in which case it would not appear.

Drag and drop linking along with the tree based representation of database record connections are both beneficial. Records can be freely connected to each other, and that those connections can be easily viewed. We believe that this basic model solves one of the most serious problems in computing, which is the separation of data into disconnected silos. With this model, some embodiments can operate to maintain all data in one collection, and the relationships between the records in the collection can be traversed easily.

This very powerful fluid data model is combined in some embodiments with a data grid concept that permits the user interface to be easy to use. In this way, programs can be developed using data grid interface design metaphors, but utilizing data grids that allow developers and users to greatly expand the accessibility and usefulness of their data.

While the multidimensional data grid is implemented in some embodiments for web applications, and a desktop environment that lives inside a web browser, other embodiments will be well suited to the traditional desktop or to future more internet centric desktops.

In some embodiments, the multidimensional data grid does not require lots of complicated coding on the part of the developer. The records of a multidimensional data grid “know” how to display themselves because the display forms 330 are in the database 104, as shown in FIG. 3. Therefore multidimensional data grids can display data with little to no situation specific programming. Historically, the formatting of data was done separately from the storage of data. This new model means that when a developer places a multidimensional data grid on a page s/he does not have to think about how any of this behavior will work. Records can be freely connected, and effectively embedded in other records, and there is little to no work on the part of the developer required.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method of displaying data from a graph database, the method comprising:
generating a user interface including a representation of a record from the graph database;
determining that the record is connected to at least one other record in the graph database; and
generating a selectable graphical element in the representation of the record in the user interface, the selectable graphical element graphically illustrating that the record is connected to at least one other record in the graph database.

2. The method of claim 1, further comprising:
displaying a representation of the at least one other record in the user interface after selection of the selectable graphical element.

3. The method of claim 2, further comprising:
determining that a second record of the at least one other record is connected to at least a third record in the graph database; and
generating a second selectable graphical element in the representation of the second record in the user interface, the second selectable graphical element graphically illustrating that the second record is connected to at least the third record in the graph database.

4. The method of claim 1, wherein generating the user interface comprises generating a user interface with a software application created with a graphical user interface builder software application.

5. The method of claim 1, wherein generating the user interface including the representation of the record from the graph database comprises displaying the record in a row and displaying fields of the record in columns.

6. The method of claim 1, wherein generating the user interface including the representation of the record from the graph database comprises displaying the representation among a list of formatted records with a custom layout.

7. The method of claim 1, wherein the user interface includes a data grid user interface object.

8. The method of claim 1, wherein the user interface includes a multi-dimensional data grid user interface object.

9. The method of claim 1, further comprising:
generating a representation of a second record from the graph database in the user interface;
determining that the second record is not connected to at least one other record in the graph database; and
generating a graphical element in the representation of the second record in the user interface, the graphical element graphically illustrating that the second record is not connected to at least one other record in the graph database.

10. The method of claim 1, wherein the selectable graphical element is selectable between a closed state and an open state, wherein the graphical element is graphically depicted in a first position when the selectable graphical element is in a closed state, and the graphical element is graphically depicted in a second position when the selectable graphical element is in the open position, and wherein when the graphical element is in the open position, a representation of at least one other record connected to the record is included in the user interface.

11. The method of claim 10, wherein the selectable graphical element is a triangle, wherein when the graphical element is in the first position, the triangle is graphically depicted as pointing toward a right side, and wherein when the graphical element is in the second position, the triangle is graphically depicted as pointing downward.

12. The method of claim 1, further comprising:
determining a type of the first record;
retrieving a display form from the graph database associated with the type of the first record; and
generating the representation of the first record according to the display form.

13. The method of claim 1, further comprising:
determining a type of the first record; and
including a label in the representation of the first record in the user interface, the label representative of the type of the first record.

14. A method of creating connections between a first record and a second record in a graph database, the method comprising:
receiving an input from an input device into at least one user interface object of a graphical user interface, the input being a drag and drop input identifying first and second records in the at least one user interface object; and
creating a connection in the graph database between the first record and the second record.

15. The method of claim 14, wherein a representation of the first record is included in the first user interface object and wherein a representation of the second record is included in the second user interface object.

16. The method of claim 15, wherein the first user interface object is part of a first application and wherein the second user interface object is part of a second application.

17. The method of claim 16, wherein the first and second records include permissions.

18. The method of claim 17, further comprising generating the first and second user interface objects and displaying only those records having permissions that a user is permitted to see based on the permissions.

19. The method of claim 14, wherein the drag and drop input further comprises:
clicking on a representation of the first record with a mouse;
dragging the representation of the first record over a representation of the second record; and
releasing the mouse while the representation of the first record is over the representation of the second record.

20. The method of claim 19, further comprising:
requesting from the graph database types of connections that are valid; and
prompting the user to select one of the types of connections from a list.

21. The method of claim 20, further comprising:
updating the at least one user interface object to graphically illustrate the connection in the graph database between the first record and the second record.

22. The method of claim 21, wherein graphically illustrating the connection comprises displaying the first record indented and below the second record in the user interface object of the graphical user interface.
